(19) United States
(12) Patent Application Publication
(10) Pub. No.: US 2017/0169571 A1
(43) Pub. Date: Jun. 15, 2017

(54) FOOT SCANNING SYSTEM

(71) Applicant: NESI TRADING CO., LTD., Taichung City (TW)

(72) Inventors: Yi-Ping Hung, Taipei City (TW); Sheng-Wen Shih, Nantou County (TW); Tsung-E Liao, Taichung City (TW)

(21) Appl. No.: 15/152,580

(22) Filed: May 12, 2016

Related U.S. Application Data
(60) Provisional application No. 62/265,999, filed on Dec. 11, 2015.

(30) Foreign Application Priority Data
Jan. 19, 2016 (TW) 105101508

(51) Int. Cl. G06T 7/00; G06T 7/60; H04N 13/02

(52) U.S. Cl. CPC G06T 7/0075; H04N 13/0203; H04N 13/0282; G06T 7/602; G06T 2207/10028; G06T 2207/30196; G06T 2200/04

(57) ABSTRACT

A foot scanning system is provided. The foot shape scanning system includes a reference device, at least one depth camera and a processing device. The reference device is disposed beside a measurement area. Each depth camera is configured to capture the measurement area to obtain an image. The processing device is coupled with the depth camera. The processing device determines a foot object in the image based on the reference device, and analyzes the foot object to calculate foot shape parameters of the foot object. Accordingly, a measurement device capable of conveniently and accurately measuring foot shape parameters is provided.

### CROSS-REFERENCE TO RELATED APPLICATION

This application claims the priority benefits of U.S. provisional application Ser. No. 62/265,999, filed on Dec. 11, 2015 and Taiwan application serial no. 105101508, filed on Jan. 19, 2016. The entirety of each of the above-mentioned patent applications is hereby incorporated by reference herein and made a part of this specification.

### BACKGROUND

Field of the Invention

The disclosure related to a measurement system and more particularly, to a foot scanning system.

Description of Related Art

Typically, most people purchase new shoes based on the shoe sizes of previously-worn shoes. However, the shoe size only reflects the length of the feet, and various shoes of the same size may have different widths and different girths. Therefore, it is very common that shoes selected only based on the shoe size do not fit the feet. To reduce the return loss of the buyer and the seller, a suitable foot measuring device is often needed to assist in obtaining individual foot parameters of a user so as to increase the convenience of purchasing shoes.

A conventional foot measuring device is commonly a mechanical foot measuring device and is used to obtain the length and the width of a foot. However, this mechanical foot measuring device usually needs a store clerk to operate or to interpret the measurement results, which induces more labor costs. As a result, commercially available automated sole image acquisition devices were developed in recent years so as to automatically calculate parameters such as the length and width of the foot shape. However, the length and the width of the foot cannot reflect the thickness of the foot, and the conventional image acquisition devices detect the foot shape by means of scanning with a mobile part, optical projecting or specific accessories (e.g., socks with a specific pattern) that are worn, which leads to inconvenience in the use of the devices.

### SUMMARY

The disclosure provides a foot scanning system capable of analyzing an image of a foot object captured by at least one depth camera to obtain foot shape parameters of the foot object.

The foot scanning system provided by the disclosure includes a reference device, at least one depth camera and a processing device. The reference device is disposed beside a measurement area. The at least one depth camera is configured to capture the measurement area to obtain an image. The processing device is coupled with the at least one depth camera. The processing device determines a foot object in the image based on the reference device in the image and analyzes the foot object to calculate at least one foot shape parameter of the foot object.

In an embodiment of the disclosure, the processing device converts at least one foot surface measurement obtained based on the image into a reference coordinate system according to an installation location of the at least one depth camera, so as to form a three-dimensional (3-D) shape of the foot object. The processing device calculates the at least one foot shape parameter according to the 3-D shape.

In an embodiment of the disclosure, the reference device has a U-shape component, and the U-shape component is used to align the foot object at a known reference point or a basis point.

In an embodiment of the disclosure, the foot scanning system further includes a sole measuring device coupled with the processing device. The sole measuring device is disposed in the measurement area and generates a shape variation in response to the foot object. The processing device analyzes the shape variation in the image to calculate the at least one foot shape parameter of the foot object.

In an embodiment of the disclosure, the sole measuring device includes a thermotropic liquid crystal, the shape variation is a liquid crystal variation. The thermotropic liquid crystal generates a thermal sole image of the foot object.

In an embodiment of the disclosure, the sole measuring device includes a plastic material such as memory foam, and the shape variation is a sunken deformation.

In an embodiment of the disclosure, the sole measuring device includes a probe array having a plurality of probes, and the shape variation is the displacement of the probes.

In an embodiment of the disclosure, two depth cameras are used to acquire the foot shape. The first depth camera is disposed in front of and above the measurement area, and the second depth camera is disposed in rear of and under the measurement area.

In an embodiment of the disclosure, M depth cameras are used to acquire the foot shape, where M is a positive integer greater than 2. The M depth cameras are disposed around and above the measurement area.

In an embodiment of the disclosure, the foot scanning system further includes a display device. The display device is coupled with the processing device, and the processing device displays the at least one foot shape parameter and an operating instruction through the display device.

To sum up, in the foot scanning system provided by the disclosure, the image containing the foot object is captured by the at least one depth camera, and the foot shape parameters of the foot object are calculated with the reference device or the sole measuring device. Accordingly, the foot scanning system provided by the disclosure can achieve an effect of automatically and accurately measuring a foot shape.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating elements of a foot scanning system according to an embodiment of the disclosure.

FIG. 2 is a schematic diagram illustrating a foot scanning system according to an embodiment of the disclosure.

FIG. 3A is a schematic side view of the foot scanning system of the embodiment depicted in FIG. 2.

FIG. 3B is a schematic bottom view of the foot scanning system of the embodiment depicted in FIG. 2.

FIG. 4 is a schematic diagram illustrating a foot scanning system according to another embodiment of the disclosure.

FIG. 5 is a schematic diagram illustrating a foot scanning system according to another embodiment of the disclosure.

FIG. 6 is a schematic diagram illustrating an image of a shape variation of a thermotropic liquid crystal according to an embodiment of the disclosure.

FIG. 7 is a schematic diagram illustrating an image of a shape variation of a plastic material according to an embodiment of the disclosure.

FIG. 8 is a schematic diagram illustrating an image of a shape variation of displacement of probes according to an embodiment of the disclosure.

FIG. 9 is a schematic diagram illustrating a foot scanning system according to another embodiment of the disclosure.

FIG. 10 is a flowchart illustrating a method for measuring a foot shape according to an embodiment of the disclosure.

### DESCRIPTION OF EMBODIMENTS

In a foot scanning system provided by the disclosure, an image of a foot object captured by at least one depth camera is analyzed, and accordingly, foot shape parameters of the foot object are calculated. In order to enhance accuracy of the calculation of the foot shape parameters and achieve the capability of automatic foot shape measurement, the disclosure further proposes an image in a variety of viewing angles by disposing a reference device and/or a sole measuring device or according to different installation locations of a plurality of depth cameras. Thereby, the reference based on which the foot shape parameters are calculated can be increased. Moreover, the foot scanning system of the disclosure can be further combined with a supporting structure and a display device to increase convenience of use for the foot scanning system of the disclosure. A plurality of embodiments in compliance of the spirit of the disclosure are provided below, and persons who apply the embodiments can adaptively adjust the embodiments based on their demands, without being limited to the written description set forth below.

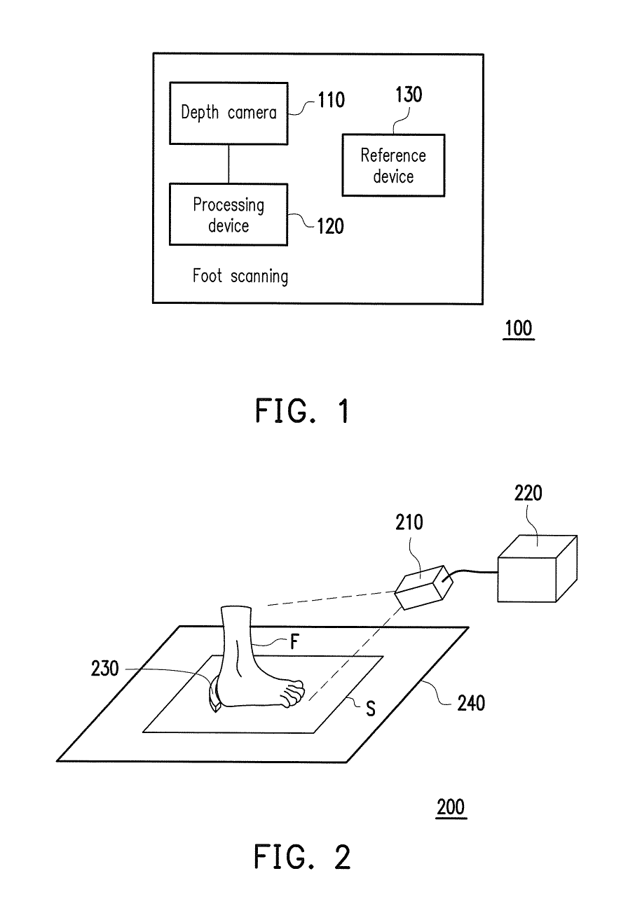

FIG. 1 is a block diagram illustrating elements of a foot scanning system according to an embodiment of the disclosure. Referring to FIG. 1, a foot scanning system 100 includes a depth camera 110, a processing device 120 and a reference device 130.

The depth camera 110 may be a depth camera or a stereoscopic camera which has photosensitive components, e.g., charge coupled devices (CCDs), complementary metal oxide semiconductor (CMOS) transistors or the like and is capable of capturing an image of an object to obtain image information with depth information or three-dimensional information. In the present embodiment, the depth camera 110 is configured to capture a measurement area in the foot scanning system 100. The measurement area may be an area for placing a measurement object (e.g., a foot or other parts), and a location, a shape and a size of the measurement area may vary with different design requirements. The foot scanning system 100 may also have one or more depth cameras 110.

The processing device 120 may at least include a processor (e.g., a central processing unit (CPU), a microprocessor, a digital signal processor (DSP), a programmable controller, an application specific integrated circuit (ASIC), a system on chip (SoC), a similar device or a combination of the aforementioned devices) and a storage unit (e.g., a fixed or movable random access memory (RAM) of any type, a read-only memory (ROM), a flash memory, a similar device or a combination of the aforementioned devices.). The processing device 120 is coupled with the depth camera 110. In the present embodiment, the processing device 120 is configured to analyze and process an image captured by the depth camera 110, so as to obtain foot shape parameters with respect to a foot object. The foot shape parameters may include information related to a foot size, such as a length, a width, a ball girth, a waist girth, an instep girth, which are not limited in the disclosure.

The reference device 130 is disposed beside the measurement area and used to let a heel location of the foot object be fixed, which serves as a reference basis for image analysis performed by the processing device 120. For instance, the processing device 120 may determine relative locations of the depth camera 110 and the reference device 130 and identify an actual location of a specific part (e.g., a heel, a sole, etc.) of the foot object based on the image. In the present embodiment, in order to conveniently fix the heel, the reference device 130 may be provided with a U-shape component. It should be noted that according to different design requirements, the reference device 130 may have components with different shapes and sizes or serve to fix other parts (e.g., toes, a sole and so on) of the foot object.

FIG. 2 is a schematic diagram illustrating a foot scanning system according to an embodiment of the disclosure. Referring to FIG. 2, a foot scanning system 200 includes a depth camera 210, a processing device 220 and a reference device 230. In the present embodiment, the reference device 230 has a U-shape component, and the reference device 230 is disposed beside a measurement area S on a substrate 240 and used to let a heel location of a foot object F be fixed. The depth camera 210 is configured to capture the measurement area S to obtain an image containing the foot object F. The substrate 240 may be made of safety glass, acrylic or a transparent or non-transparent weight carrying material or the like, which is capable of carrying a foot object F of a user placed in the measurement area S. Additionally, in the present embodiment, the foot object F refers to a human foot to be measured.

In a measurement scenario, the user may place a foot object F whose foot shape parameters are to be measured on the measurement area S of the substrate 240 and abuts the foot object F against the U-shape component of the reference device 230. The U-shape component may serve as a reference point or a basis point for measuring the foot object F to provide an exact location of the heel of the foot object F. The depth camera 210 may capture the measurement area S to obtain one or more images containing the foot object F or the reference device 230. Then, the depth camera 210 transmits the obtained images to the processing device 220. The processing device 220 converts foot surface measurements obtained based on the images into a reference coordinate system according to relative installation locations of the depth camera 210 and the reference device 230, so as to form a three-dimensional (3-D) shape of the foot object F.

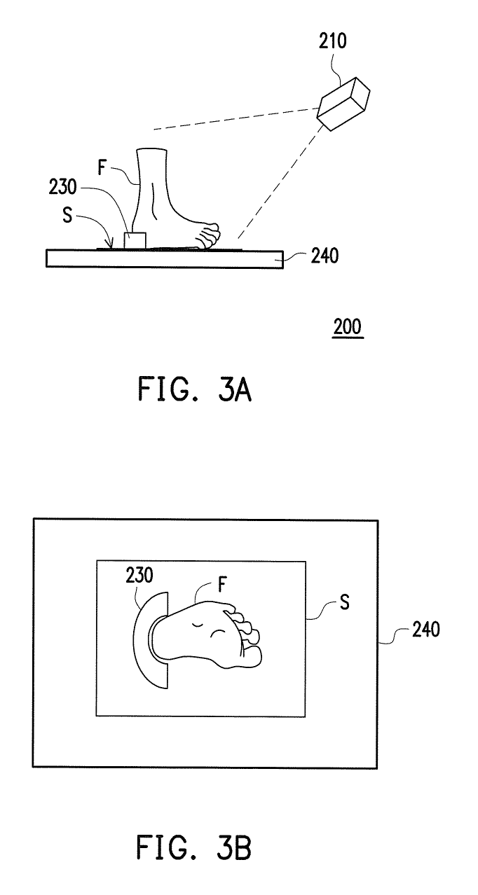

FIG. 3A is a schematic side view of the foot scanning system of the embodiment depicted in FIG. 2. Referring to FIG. 3A, since the foot object F is abutted against the reference device 230, the processing device 220 may obtain the image containing the reference device 230 and the foot object F through the depth camera 210. FIG. 3B is a schematic bottom view of the foot scanning system of the embodiment depicted in FIG. 2. The foot object F is abutted against the reference device 230. The processing device 220 may further obtain a depth image captured by the depth camera 210 to obtain a relative location of the reference device 230 with respect to the depth camera 210. Then, the processing device 220 simulates the 3-D shape of the foot object F based on the relative location of the reference device 230 with respect to the depth camera 210 to calculate the foot shape parameters of the foot object F. For instance, the processing device 220 may generate a 3-D image (i.e., an image containing the 3-D shape of the foot object F) based on depth information in the image and estimate the foot shape parameters (e.g., the length, the width, the ball girth, the waist girth, the instep girth and so on) of the foot object F according to the 3-D image.

In the embodiment illustrated in FIG. 2 and FIG. 3, one depth camera 210 is disposed in front of and above the measurement area S (e.g., in front of and above the toes of the foot object F) to capture an image of the forefoot of the foot object F, so as to estimate the foot shape parameters (e.g., the length, the width, the ball girth, the waist girth, the instep girth and so on). However, the installation location and the number of the depth camera 210 may be adjusted according to different design requirements and accordingly obtain images of the measurement area in different viewing angles, so as to improve accuracy of measuring the foot shape parameters.

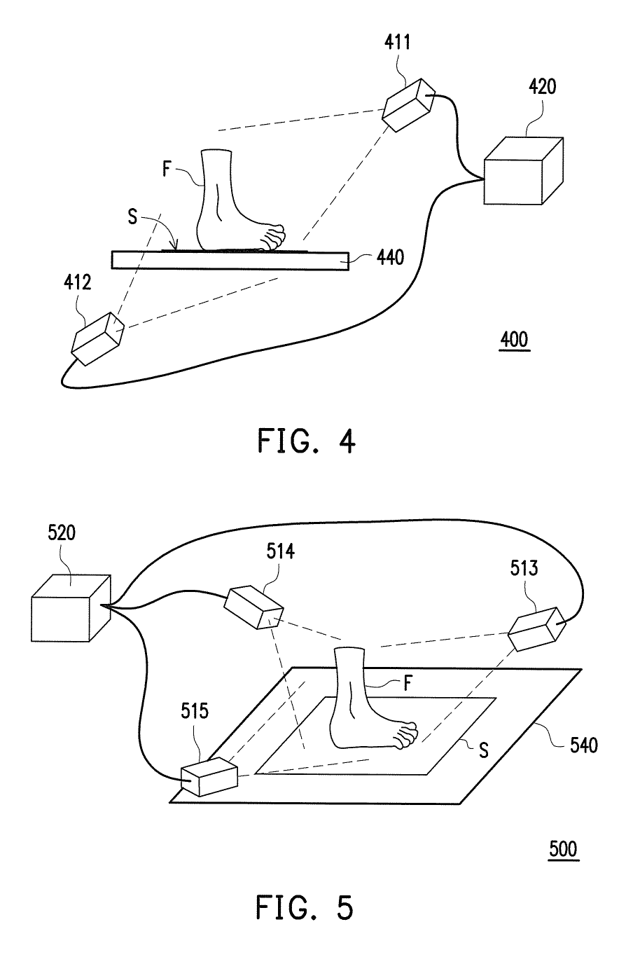

For instance, FIG. 4 is a schematic diagram illustrating a foot scanning system according to another embodiment of the disclosure. Referring to FIG. 4, a foot scanning system 400 includes a depth camera 411, a depth camera 412, a transparent substrate 440 and a processing device 420. The foot scanning system 400 of the present embodiment is different from that foot scanning system 200 illustrated in FIG. 2 and FIG. 3 in the foot scanning system 400 capturing images of the measurement area S by using the depth camera 411 and the depth camera 412 respectively. The depth camera 411 and the depth camera 412 are respectively coupled with the processing device 420. The depth camera 411 is disposed in front of and above the measurement area S (or the toes of the foot object F) of the transparent substrate 440, and the depth camera 412 is disposed in rear of and under measurement area S (or the heel of the foot object F) of the transparent substrate 440.

The depth camera 411 and the depth camera 412 are respectively used to capture a forefoot image and a heel image of the foot object F. Then, the processing device 420 converts foot surface measurements from different viewing angles captured by the depth camera 411 and the depth camera 412 into a reference coordinate system to simulate a 3-D shape of the foot based on relative installation locations of the depth camera 411 and the depth camera 412. The image obtained by each depth camera (e.g., the depth camera 411 or the depth camera 412) may be used solely or in combination. For example, the processing device 420 may combine the foot image obtained by the depth camera 411 or the depth camera 412 as at least one 3-D image by image processing algorithm, such as an edge recognition algorithm and a depth recognition algorithm.

It should be noted that the depth camera 411 disposed in front of and above the measurement area S to capture the forefoot image of the foot object F in the present embodiment facilitates estimating the foot shape parameters with respect to the forefoot of the foot object F, such as the ball girth, the waist girth, the instep girth. The depth camera 412 disposed in rear of and under the measurement area S to capture the heel image of the foot object F facilitates estimating foot shape parameters with respect to the heel portion. In other embodiments, the depth camera 411 and the depth camera 412 may be disposed at different locations to capture the images of the foot object F in different viewing angles according to different demands of the user for measuring different foot shape parameters. In addition, the transparency of the transparent substrate 440 is for the convenience of measurement, but the material of the substrate 440 is not particularly limited in the disclosure.

In an embodiment, the foot scanning system 100 illustrated in FIG. 1 may include M depth cameras 110 disposed around and above the measurement area (e.g., the measurement area S illustrated in FIG. 2), and M is a positive integer greater than 2 (e.g., 3, 4, 5 and so on). In the surrounding configuration, each of the M depth cameras is disposed with a first specific distance (e.g., 10 cm, 15 cm, 20 cm or the like) or an arbitrary distance from the measurement area, each of the M depth cameras is separated from one another with a second specific distance (e.g., 8 cm, 10 cm, 12 cm or the like) or an arbitrary distance, and all of the M depth cameras photograph the measurement area.

For instance, FIG. 5 is a schematic diagram illustrating a foot scanning system according to another embodiment of the disclosure. Referring to FIG. 5, a foot scanning system 500 of the present embodiment is different from the foot scanning system 400 illustrated in FIG. 4 in the foot scanning system 500 including a depth camera 513, a depth camera 514 and a depth camera 515. The depth camera 513, the depth camera 514 and the depth camera 515 are respectively coupled with a processing device 520 and disposed around and above the measurement area S. The depth camera 513, the depth camera 514 and the depth camera 515 respectively photograph the foot object F from different viewing angles to capture a plurality of images containing the foot object F and transmit the images to the processing device 520. The processing device 520 integrates foot surface measurements from different viewing angles and converts the foot surface measurements into a reference coordinate system using a relative relationship of the depth cameras calibrated in advance, so as to establish a 3-D shape of the foot object F. The image obtained by each depth camera (e.g., the depth camera 513, the depth camera 514 or the depth camera 515) may be used solely or in combination.

It should be noted that installation locations and photographing angles of the depth camera 513, the depth camera 514 and the depth camera 515 illustrated in FIG. 5 may vary with design requirements and be disposed as movable or fixed. Additionally, the reference device 230 illustrated in FIG. 2 and FIG. 3 may also be installed in the foot scanning system 400 illustrated in FIG. 4 and the foot scanning system 500 illustrated in FIG. 5, such that the accuracy of the estimating the foot shape parameters may be improved, and the number of depth cameras may be reduced. Details related to the reference device 230 used as the reference basis of the foot object F may refer to the description related to FIG. 2 and FIG. 3 and will not be repeated hereinafter. Moreover, the shapes, the appearances and the installation locations of the processing devices 220, 420 and 520 in FIG. 2, FIG. 4 and FIG. 5 are merely examples illustrated for descriptive convenience and construe no limitations to the embodiments of the disclosure.

Furthermore, in order to achieve better accuracy of estimating the foot shape parameters, the foot scanning system 100 illustrated in FIG. 1 further includes a sole measuring device (not shown). The sole measuring device is coupled to the processing device 120. A measurement area (e.g., the measurement area S illustrated in FIG. 2 which is integrated with the substrate 240) is configured on the sole measuring device and configured for carrying a foot object (e.g., the foot object F illustrated in FIG. 2). The sole measuring device generates a shape variation in response to the foot object. The processing device 120 analyzes the shape variation of the sole measuring device in the image captured by the depth camera 110 to calculate foot shape parameters of the foot object. In the existence of the sole measuring device, not only the numeric value of ball girth may be calculated more accurately, but also a foot shape type of the user, such as a high foot arch, a normal foot arch, or a flat foot, may be further identified according to the shape of the foot arch or the height of the foot arch of the user. Such information may also be used to recommend or customize suitable shoes. In addition, as different sole measuring devices are selected, parameters such as the locations of the metatarsal-phalangeal joints of the big toe and the little toe, the type of the foot arch, and/or the height of the foot arch may be calculated.

In the present embodiment, the sole measuring device may include a thermotropic liquid crystal, plastic material or a probe array having a plurality of probes. Three embodiments are provided below for describing measurement scenarios of the sole measuring device of different types.

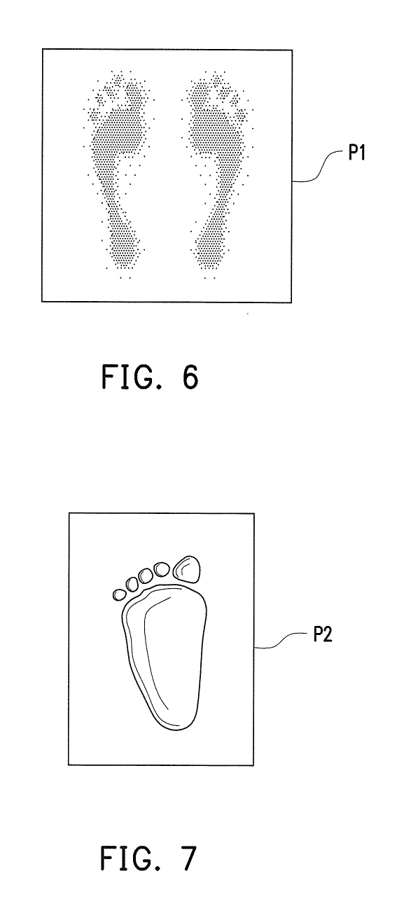

FIG. 6 is a schematic diagram illustrating an image of a shape variation of a thermotropic liquid crystal according to an embodiment of the disclosure. Referring to FIG. 2 and FIG. 6 simultaneously, it is assumed that the sole measuring device includes a thermotropic liquid crystal, and a scanning area of the sole measuring device is the measurement area S. When the user steps on the measurement area S of the substrate 240, in response to a temperature (e.g., a body temperature) of the foot object F, the sole measuring device generates a liquid crystal variation (i.e., a shape variation) and generates a thermal image P1 according to the liquid crystal variation. After the foot object F is removed from the measurement area S, the thermal image P1 is captured by the depth camera 210. The processing device 220 analyzes the thermal image P1 so as to obtain a footprint region of the foot object F and calculate parameters with respect to the sole.

FIG. 7 is a schematic diagram illustrating an image of a shape variation of a plastic material according to an embodiment of the disclosure. Referring to FIG. 2 and FIG. 7 simultaneously, it is assumed that the sole measuring device includes a plastic material (which is formed by a material such as memory foam, for example), and a scanning area of the sole measuring device is the measurement area S. When the user steps on the measurement area S of the substrate 240, the sole measuring device generates a sunken deformation (i.e., a shape variation) in response to the foot object F. After the foot object F is removed from the measurement area S, an image P2 of the sunken deformation is captured by the depth camera 210. The processing device 220 analyzes the image P2 so as to obtain a sunken footprint of the foot object F and calculate parameters with respect to the sole of the foot object F.

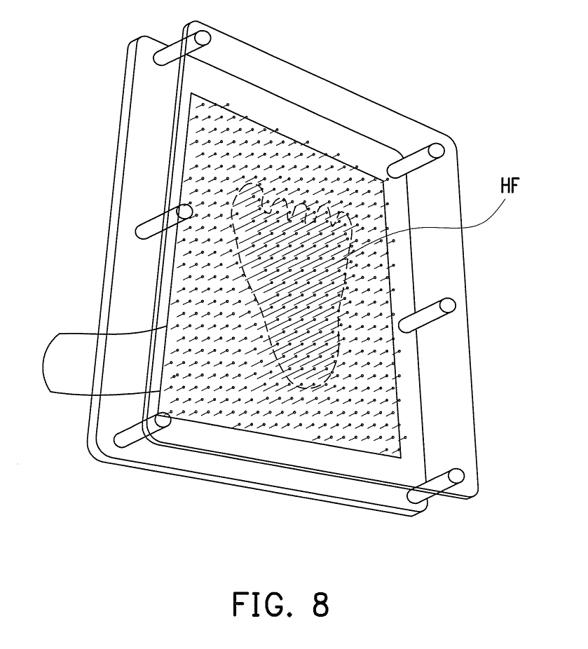

FIG. 8 is a schematic diagram illustrating an image of a shape variation of displacement of probes according to an embodiment of the disclosure. Referring to FIG. 2 and FIG. 8 simultaneously, it is assumed that the sole measuring device (which is integrated with the substrate 240 illustrated in FIG. 2) includes a probe array having a plurality of probes, and the probes are arranged densely and evenly in the measurement area S. Each probe is installed in a hole with adaptive friction and does not automatically move without an external force. A flat panel driven by a solenoid is disposed under the probe array, and the flat panel is used to push each probe up into a specified location when the solenoid is electrified. When the user steps on the measurement area S of the substrate 240, the probes are pushed down (i.e., displacement occurs to the probes) to reflect the shape of the sole of the foot object F. After the foot object F is removed from the measurement area S, a sunken footprint HF generated by the displacement of the probes is captured by the depth camera 210. The processing device 220 analyzes the sunken footprint HF in the image so as to obtain a sunken footprint HF and calculate parameters such as the locations of the metatarsal-phalangeal joints of the big toe and the little toe, the type of the foot arch, and/or the height of the foot arch.

FIG. 9 is a schematic diagram illustrating a foot scanning system according to another embodiment of the disclosure. Referring to FIG. 9, a foot scanning system 900 includes a depth camera 910, a processing device 920, a reference device 930, a substrate 940, a display device 960 and a support means 970. A measurement area of a sole measuring device (not shown) is a measurement area S on the substrate 940. Functions and operations of the depth camera 910, the processing device 920, the reference device 930 and the substrate 940 may refer to the descriptions related to FIG. 2 to FIG. 8. The foot scanning system 900 is different from the foot scanning system 200 illustrated in FIG. 2 and FIG. 3 in the foot scanning system 900 further including a display device 960 and being installed on the support means 970. The display device 960 is configured to display foot shape parameters and operating instructions. For instance, after the foot scanning system 900 is activated, the user may be guided by the operating instruction to step on a predetermined location of a lens of the depth camera 910, such that the user is guided to complete the foot scanning operation. If the foot scanning system 900 further includes an audio output device (e.g., a speaker), the operating instruction may also be output through an audio (e.g., a speech). The support means 970 is used for assembling each part (e.g., the depth camera 910, the processing device 920, the reference device 930 and the substrate 940) and serves as a handrail to help the user to balance the body.

It should be noted that the shape, the size and the appearance of each part of the foot scanning system 900 may vary with design requirements, and the embodiments of the disclosure are not limited thereto. Moreover, in other embodiments, the display device 960 and the processing device 920 may also be implemented by using one or more electronic devices with display and computing functions, such as a desktop computer, a personal computer, a tablet computer, a thin client, a smart cell phone, a personal digital assistant (PDA) and so on.

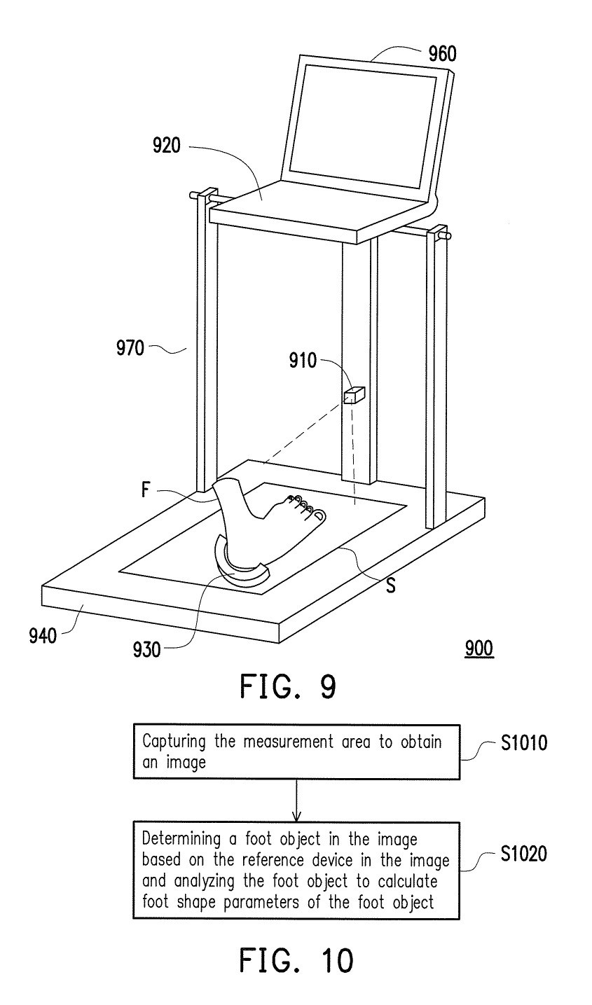

In order to assist persons with ordinary skill in the art to understand an operation process of the foot scanning system, description related thereto will be continuously set forth below. FIG. 10 is a flowchart illustrating a method for measuring a foot shape according to an embodiment of the disclosure. Referring to FIG. 2 and FIG. 10, the method of measuring a foot shape of the present embodiment is at least adapted to, for example, the foot scanning system 200 illustrated in FIG. 2 (which is also adapted to the foot scanning systems 100, 400 and 500 illustrated in FIG. 1, FIG. 4 and FIG. 5). In step S1010, the foot scanning system 200 captures the measurement area S to obtain an image by using the depth camera 210. In step S1020, the foot scanning system 200 determines a foot object F in the image based on the reference device 230 in the image and analyzes the foot object F to calculate foot shape parameters of the foot object by using the processing device 220.

In addition, instructions, recommendations and implementation descriptions for a variety of modifications and applications of the foot scanning system of the present embodiment may be learned from the embodiments above and thus, will not be repeated.

To summarize, in the embodiments of the disclosure, the proposed foot scanning system has the at least one depth camera and the reference device, such that the foot object and the reference device can be photographed by using the depth cameras to calculate the foot shape parameters of the foot object. Moreover, the foot scanning system can be further operated with a sole measuring device to improve the accuracy of calculating the foot shape parameters. On the other hand, the foot shape parameters of a specific part of the foot object can be obtained through the depth cameras in different numbers and disposed in different locations, so as to enhance the accuracy of estimation. Moreover, in the embodiments of the disclosure, the foot scanning system can further disposed on the support means to assist the user to keep balance, and the operating instruction and the foot shape parameters can be displayed by the display device so as to improve the convenience of use.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A foot scanning system, comprising:
a reference device, disposed beside a measurement area;
at least one depth camera, configured to capture the measurement area to obtain an image; and
a processing device, coupled with the at least one depth camera, determining a foot object in the image based on the reference device in the image and analyzing the foot object to calculate at least one foot shape parameter of the foot object.

2. The foot scanning system according to claim 1, wherein the processing device converts at least one foot surface measurement obtained based on the image into a reference coordinate system according to an installation location of the at least one depth camera, so as to form a three-dimensional (3-D) shape of the foot object, and the processing device calculates the at least one foot shape parameter according to the 3-D shape.

3. The foot scanning system according to claim 1, wherein the reference device has a U-shape component, and the U-shape component is used to let the foot object be fixed.

4. The foot scanning system according to claim 1, further comprising:
a sole measuring device, coupled with the processing device, wherein the sole measuring device is disposed in the measurement area and generates a shape variation in response to the foot object, and the processing device analyzes the shape variation in the image to calculate the at least one foot shape parameter of the foot object.

5. The foot scanning system according to claim 4, wherein the sole measuring device comprises a thermotropic liquid crystal, the shape variation is a liquid crystal variation, and the thermotropic liquid crystal generates a thermal image according to the liquid crystal variation in response to the foot object.

6. The foot scanning system according to claim 4, wherein the sole measuring device comprises a plastic material, and the shape variation is a sunken deformation.

7. The foot scanning system according to claim 4, wherein the sole measuring device comprises a probe array having a plurality of probes, and the shape variation is displacement of the probes.

8. The foot scanning system according to claim 1, wherein the at least one depth camera comprises a first depth camera and a second depth camera, the first depth camera is disposed in front of and above the measurement area, and the second depth camera is disposed in rear of and under the measurement area.

9. The foot scanning system according to claim 1, wherein the at least one depth camera comprises M depth cameras, M is a positive integer greater than 2, and the M depth cameras are disposed around and above the measurement area.

10. The foot scanning system according to claim 1, further comprising:
a display device, coupled with the processing device, wherein the processing device displays the at least one foot shape parameter and an operating instruction through the display device.
